(19) United States
(12) Patent Application Publication
(10) Pub. No.: US 2017/0186009 A1
(43) Pub. Date: Jun. 29, 2017

(54) SYSTEMS AND METHODS TO IDENTIFY ILLEGITIMATE ONLINE ACCOUNTS

(71) Applicant: Facebook, Inc., Menlo Park, CA (US)

(72) Inventor: Michael Francis Zolli, Austin, TX (US)

(21) Appl. No.: 14/981,500

(22) Filed: Dec. 28, 2015

(51) Int. Cl. G06Q 20/40; G06Q 50/00; G06Q 20/10

(52) U.S. Cl. CPC G06Q 20/4016; G06Q 20/10; G06Q 50/01

(57) ABSTRACT

Systems, methods, and non-transitory computer readable media are configured to determine feature metrics associated with a value of a feature relating to a set of accounts. A combined score associated with the value of the feature can be generated based on a Pythagorean expectation formula and the feature metrics. At least one rule can be applied to redress illegitimate accounts from the set of accounts based on at least the combined score.

### FIELD OF THE INVENTION

The present technology relates to identifying illegitimate accounts. More particularly, the present technology relates to techniques for identifying illegitimate accounts based on dynamic fraud data.

### BACKGROUND

Many users of computing devices (or systems) frequently browse web sites, access online media content, or otherwise perform transactions in network environments. Users with access to the Internet can perform online shopping, watch streaming movies, download software, utilize social networking services, and accomplish many other tasks. In one example, users of a social networking service or system can publish advertisements, purchase applications, give gifts, distribute promotions, or conduct various other transactions. Sometimes, an illegitimate user can attempt to publish fraudulent or otherwise illegitimate advertisements or conduct other illegitimate actions. In another example, users can provide their payment information (e.g., credit card information, bank account information) to an online service in order to fund various online activities. However, occasionally, an illegitimate user can attempt to illegitimately gain access to a legitimate user's payment information or otherwise compromise the legitimate user's account with the online service.

Accordingly, when a user of an online service, such as a social networking system, participates in various activities that involve the use of financial instruments compatible or operable with the online service, the financial instruments of the user can sometimes be stolen, illegitimately used, or otherwise compromised. These and other similar concerns can reduce the overall user experience associated with using online services.

### SUMMARY

Various embodiments of the present technology can include systems, methods, and non-transitory computer readable media configured to determine feature metrics associated with a value of a feature relating to a set of accounts. A combined score associated with the value of the feature can be generated based on a Pythagorean expectation formula and the feature metrics. At least one rule can be applied to redress illegitimate accounts from the set of accounts based on at least the combined score.

In an embodiment, the generation of a combined score comprises: generating a first score based on a Pythagorean expectation formula applied to a first set of feature metrics.

In an embodiment, the first set of feature metrics comprises a number of disabled accounts and a number of active accounts.

In an embodiment, the generation of a combined score further comprises: generating a second score based on a Pythagorean expectation formula applied to a second set of feature metrics.

In an embodiment, the second set of feature metrics comprises a number of manually disabled accounts and a number of disabled accounts that were not manually disabled.

In an embodiment, the generation of a combined score further comprises averaging the first score and the second score to generate the combined score.

In an embodiment, the application of at least one rule comprises: selecting criteria relating to at least one of a precision metric rate, a recall rate, and a false positive rate of a model that generates model scores for accounts relating to a probability of illegitimacy; and determining a threshold value based on a model score that satisfies the selected criteria.

In an embodiment, the at least one rule is further based on the threshold value.

In an embodiment, the application of at least one rule further comprises: disabling an account associated with the value of the feature when the combined score satisfies the threshold value.

In an embodiment, the application of at least one rule further comprises: not disabling an account associated with the value of the feature when the combined score does not satisfy the threshold value.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example fraud identification module, according to an embodiment of the present technology.

FIG. 2 illustrates an example scoring module, according to an embodiment of the present technology.

FIG. 3 illustrates an example method to apply a rule to redress illegitimate accounts based on a combined score, according to an embodiment of the present technology.

FIG. 4 illustrates an example method to generate a combined score to identify illegitimate accounts, according to an embodiment of the present technology.

FIG. 5 illustrates an example method to disable an account based on combined score in relation to a threshold value, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Identifying Fraudulent Accounts

People often conduct transactions or engage in activities that involve the use of financial instruments, such as credit cards, bank accounts, electronic or digital payment services, etc. When users of computing devices utilize financial instruments in a networked environment (e.g., Internet, cellular data network, online service, social networking system, etc.), the users must often provide information about their financial instruments. In some cases, illegitimate or fraudulent users can attempt to steal information about the financial instruments of legitimate online service users. In some cases, an illegitimate user can attempt to link a stolen financial instrument with a legitimate user's online service account. Furthermore, in some instances, illegitimate users can attempt to create accounts with social networking systems or services and utilize those accounts to conduct illegitimate activities within the social networking systems. For example, an illegitimate user can create a plurality of accounts with a social networking system in hopes that at least some accounts will be able to successfully publish one or more illegitimate advertisements.

Conventional approaches to identifying illegitimate accounts (or users, activities, transactions, events, and/or other incidents, etc.) generally utilize rules or policies to target specific illegitimate schemes that have particular trends, patterns, properties, traits, or characteristics in common. The rules or policies are often based on linear relationships, such as simplistic ratios, that do not accurately or reliably identify illegitimate accounts and activities. For example, for a particular value relating to an attribute of an account, one type of such rules or policies is commonly based on a number of illegitimate accounts divided by a number of all accounts. As just one observation with respect to this example, the identification of one illegitimate account out of a small number of total accounts can sometimes provide a signal of illegitimacy that may be exaggerated in view of the small number of total accounts. Accordingly, conventional approaches can be inaccurate, unreliable, and misleading.

An improved approach rooted in computer technology overcomes the foregoing and other disadvantages associated with conventional approaches specifically arising in the realm of computer technology. Systems, methods, and computer readable media of the present technology can analyze one or more feature values corresponding to features associated a set of accounts. The set of accounts can be associated with recent transactions that were performed within a selected time interval. Feature metrics can be determined for the one or more feature values. Feature metrics can include categories of data relating to, for example, numbers of accounts from the set of accounts that have been disabled and a number of accounts from the set of accounts that are active. A first score and a second score can be calculated based on the feature metrics. Each calculation can be based on a Pythagorean expectation formula. The first score and the second score can be averaged to generate a combined score. A threshold value can be determined from a dynamic rethresholding model that can determine a model score reflecting a probability that an account is illegitimate. The threshold value can be based on a model score that satisfies selected criteria relating to a desired precision rate for identifying illegitimate accounts, a recall rate associated with identifying illegitimate accounts, or a false positive rate associated with identifying illegitimate accounts. A rule can be applied based on the combined score in relation to the threshold value. For example, if the combined score associated with a feature value is greater than or equal to the threshold value, the account can be determined to be illegitimate. Appropriate action can be taken in response to a determination of account illegitimacy. More details regarding the present technology are described herein.

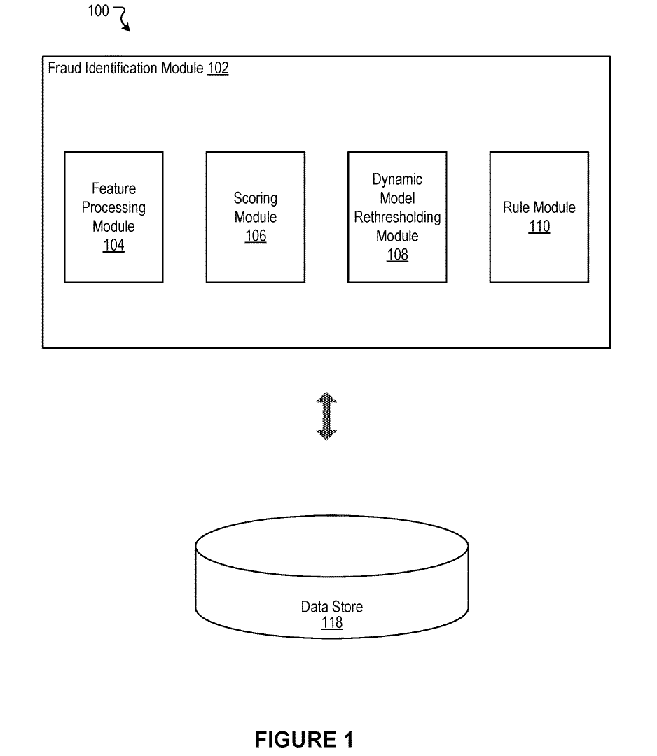

FIG. 1 illustrates an example system 100 including an example fraud identification module 102 configured to determine scores for identifying illegitimate accounts, according to an embodiment of the present technology. Rules to identify illegitimate accounts can be based on the scores in relation to threshold values. The threshold values can be dynamically selected from models for determining probabilities that accounts are illegitimate. The fraud identification module 102 can include a feature processing module 104, a scoring module 106, and a dynamic model rethresholding module 108, and a rule module 110. The example system 100 also can include a data store 118. In some embodiments, the fraud identification module 102 can communicate with or be integrated within an associated risk system implemented by an online service, such as a social networking system. The risk system can be configured to facilitate various tasks and operations associated with managing risk, such as financial risk associated with illegitimate or fraudulent transactions conducted with the online service. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the fraud identification module 102 can be implemented in any suitable combinations.

The feature processing module 104 can acquire a set of accounts and analyze information relating to the set of accounts. The set of accounts can be accounts that have performed transactions with an online entity, such as a social networking system. For example, the set of accounts can include accounts created by advertisers for advertising on a social networking system or other users who have conducted financial transactions on the social networking system. The information relating to the set of accounts can be associated with any selected time interval. The selected time interval can be any suitable historical duration of time. In one example, the set of accounts can be accessed, received, or otherwise acquired from the associated risk system or the data store 118.

The feature processing module 104 can be configured to access and analyze for each account in the set one or more features or one or more feature combinations. In some instances, features can generally refer to attributes or other information associated with accounts. For example, features can be associated with at least one of an advertisement title, an advertisement image, an advertisement landing page identifier, a social networking system identifier for an advertisement landing page component, an advertisement body text portion, an advertisement landing page domain, a source internet protocol (IP), a credit card identification number, a latest administered page name, a campaign name, a user agent, or an advertisement image identifier. There can be many variations and other possibilities.

Feature combinations can refer to a collection of features. The one or more feature combinations can be based on any combination of the one or more features as well as other suitable features. Although certain features are discussed herein for purposes of illustration, the present technology also can apply to feature combinations.

The feature processing module 104 can be configured to determine feature metrics for one or more values of features or one or more feature combinations. For example, a feature relating to advertisement title can have a feature value of “Dr. Raf's Proven Slimming Diet”. Feature metrics can generally refer to statistics or performance metrics associated with the values of one or more features or one or more feature combinations. In some embodiments, the feature processing module 104 can determine feature metrics for a particular value (or values) of a feature (or feature combination) by providing the particular value of the feature into a statistical analyzer that can output the feature metrics. The feature metrics for a particular value of a feature can include, for example, a number of accounts with the particular value of the feature that have been disabled, a number of accounts with the particular value of the feature that are active (i.e., not disabled), a number of accounts with the particular value of the feature that have been manually disabled, and a number of accounts with the particular value of the feature that have been disabled but that have not been disabled manually (i.e., automatically disabled). Other feature metrics can be used in other embodiments. In some implementations, the feature metrics can be updated at selected times or intervals.

The scoring module 106 can generate a combined score based on feature metrics. The combined score can be based on a combination of individual scores determined from certain feature metrics. The combined score can be used to formulate or apply a rule in the identification and redress of an illegitimate account. The scoring module 106 is discussed in more detail herein.

The dynamic model rethresholding module 108 can determine a plurality of model scores for a set of accounts. Each model score in the plurality of model scores can be associated with at least one account in the set of accounts. A model score can generally indicate a likelihood or probability that an associated account (e.g., an account having the model score) is an illegitimate account. In some instances, a model score can correspond to a numerical value between 0 and 1, where a higher model score for an account indicates a higher likelihood that the account is illegitimate. The dynamic model rethresholding module 108 can determine a model score for each account in the set of accounts.

The dynamic model rethresholding module 108 can utilize one or more models to determine the model score for each account reflecting a level of illegitimacy with the account. The models can correspond to logistic regression models, gradient boosted tree models, and/or other similar models. The training of each model can produce at least one respective model threshold for the model. In one example, when an account is determined based on a model to have a model score surpassing the model threshold for the model, then the account can be identified as being illegitimate. In some cases, a particular model can be designed for and utilized in identifying accounts associated with a particular illegitimate scheme. Illegitimate schemes can include, for example, compromised fraud schemes, stolen financial instrument schemes, bank account fraud schemes, failed payment schemes, and various other illegal or fraudulent schemes.

The dynamic model rethresholding module 108 can rank the plurality of model scores in descending order. In one example, the plurality of model scores have numerical values between 0 and 1, such that the dynamic model rethresholding module 108 can rank the model scores based on their numerical values. In some instances, the dynamic model rethresholding module 108 can rank the plurality of model scores by sorting the models scores in descending order based on their values.

The dynamic model rethresholding module 108 can determine or acquire one or more model score metrics for each model score based on information about one or more accounts associated with each model score. The one or more model score metrics for each unique model score can include, for example, statistics, properties, characteristics, and various other information related to the one or more accounts associated with each model score. The one or more model score metrics can include, for example, a running total quantity of accounts associated with each model score and all higher model scores, a running total quantity of disabled accounts associated with each model score and all higher model scores, and a running total quantity of active accounts associated with each model score and all higher model scores. For example, if there are 0 accounts having a model score of 1.00, 100 accounts having a model score of 0.99, and 200 accounts having a model score of 0.98, then the dynamic model rethresholding module 108 can determine the running total quantity of accounts associated with the model score of 0.99 (and all higher model scores) as being 100 accounts, and can determine the running total quantity of accounts associated with the model score of 0.98 (and all higher model scores) as being 300 accounts, and so forth. Variations and other model score metrics are possible.

The dynamic model rethresholding module 108 can acquire or select specified criteria for selecting a model threshold value utilized in identifying illegitimate accounts. The specified criteria can be based on one or more model score metrics. The specified criteria can be associated with at least one of a precision rate associated with identifying illegitimate accounts, a recall rate associated with identifying illegitimate accounts, and a false positive rate associated with identifying illegitimate accounts. The dynamic model rethresholding module 108 can determine the precision rate, the recall rate, and the false positive rate for identifying illegitimate accounts. The precision rate for identifying illegitimate accounts can be determined based on a quantity of disabled accounts divided by a quantity of total accounts. The recall rate associated with identifying illegitimate accounts can be determined based on a quantity of illegitimate accounts at or above a model threshold value divided by a quantity of total illegitimate accounts. The false positive rate associated with identifying illegitimate accounts can be determined based on a quantity of active accounts at or above a model threshold value divided by a quantity of total active accounts.

The dynamic model rethresholding module 108 can select a model threshold value as corresponding to a lowest ranked model score that satisfies the specified criteria. The selection of the model threshold value can be dynamic in that the selecting of the model threshold value is based on the lowest ranked model score, which in turn is further based on the ranking of the plurality of model scores. As such, when new accounts are present, the ranking of the model scores can change. When the ranking of the model scores changes, the selecting of the model threshold value can be adjusted accordingly, thereby resulting in the dynamic selection of the model threshold value. Additionally or alternatively, when the specified criteria changes, the selecting of the model threshold value can change as well, thereby contributing to the dynamic quality of the selection of the model threshold value. Upon determination of specified criteria for selecting a model threshold value, the model threshold value can be selected to satisfy the specified criteria. In one example, the specified criteria can require the false positive rate to have a maximum allowable value of 0.05%. As such, in this example, the model threshold value is selected to satisfy the specified criteria requiring the false positive rate to be at most 0.05%.

In some embodiments, the threshold values can include a first set of threshold values and a second set of threshold values. The threshold values in the first set can be higher than threshold values in the second set. The first set of threshold values can, for example, be associated with automatically disablement, such that a rule automatically disables accounts with a particular feature or feature combination when the first set of threshold values are met. The second set of threshold values can, for example, be associated with manual review, such that a rule causes accounts with a particular feature or feature combination to be queued for manual review when the second set of threshold values are met but the first set of threshold values are not met.

The rule module 110 can implement one or more rules for dynamically identifying and redressing illegitimate accounts. A rule can be based on a combined score associated with a feature value as determined by the scoring module 106 and on a threshold value determined by the dynamic model rethresholding module 108. The rule module 110 can compare the combined score in relation to the threshold value and prompt certain remedial action or no action based on the comparison. For example, if the combined score satisfies (e.g., is equal to or greater than) the threshold value, the rule module 110 can determine that accounts associated with the feature value have a high probability of being illegitimate. Accordingly, the rule module 110 can prompt remedial action, such as automatic disabling of the accounts or queuing the accounts for manual review. If the combined score does not satisfy (e.g., is less than) the threshold value, the rule module 110 can determine that accounts associated with the feature do not have a high probability of being illegitimate and accordingly prompt no action in relation to the accounts. In other implementations, a first score relating to disabled accounts or a second score relating to manually disabled accounts, which can be aggregated to create the combined score as discussed in more detail herein, can be used in a rule instead of the combined score.

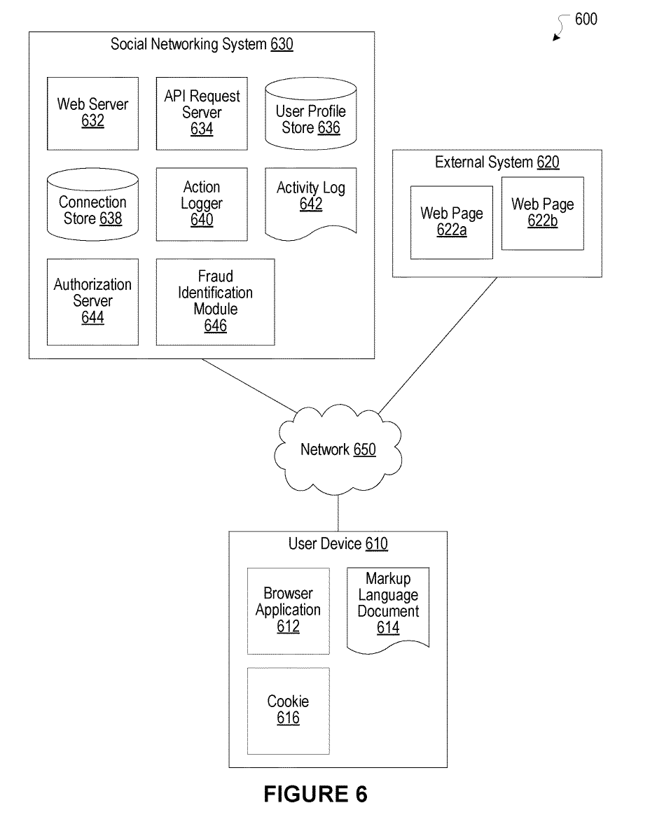

In some embodiments, the fraud identification module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the fraud identification module 102 can be, in part or in whole, implemented as software running on one or more computing devices or systems, such as on a server or a client computing device. For example, the fraud identification module 102 can be, in part or in whole, implemented within or configured to operate in conjunction or be integrated with a social networking system (or service), such as a social networking system 630 of FIG. 6. As another example, the fraud identification module 102 can be implemented as or within a dedicated application (e.g., app), a program, or an applet running on a user computing device or client computing system. In some instances, the fraud identification module 102 can be, in part or in whole, implemented within or configured to operate in conjunction or be integrated with client computing device, such as a user device 610 of FIG. 6. It should be understood that many variations are possible.

The data store 118 can be configured to store and maintain various types of data, such as the data relating to support of and operation of the fraud identification module 102. The data can include data relating to, for example, accounts, features, feature values, feature metrics, combined scores, model scores, model score metrics, threshold values, rules, etc. The data store 118 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the fraud identification module 102 can be configured to communicate and/or operate with the data store 118.

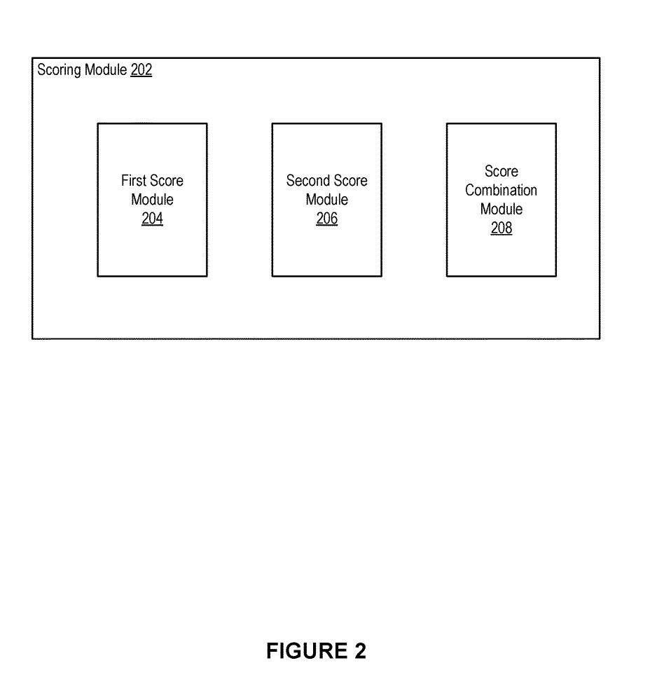

FIG. 2 illustrates an example scoring module 202, according to an embodiment of the present technology. The scoring module 202 can generate, for a value of a feature, scores based on feature metrics associated with the value of the feature. The scores can be based on a Pythagorean expectation formula. The scores can constitute estimates regarding a level of fraud associated with a feature value. The scores can be combined to generate a combined score. The combined score can be used for a rule to prompt action in response to a determination that an account is associated with a high probability of illegitimacy. In some embodiments, the scoring module 106 of FIG. 1 can be implemented with the scoring module 202. The scoring module 202 can include a first score module 204, a second score module 206, and a combined score module 208.

The first score module 204 can generate a first score relating to disabled accounts A based on a first set of feature metrics. The first score relating to disabled accounts A can be calculated according to the following formula:

$$A = \frac{{D}^{2}}{{D}^{2} + {N}^{2}}$$

where D=number of disabled accounts and where N=number of active accounts. In some embodiments, a range of the first score relating to disabled accounts A is [0, 1]. For a particular feature value, a value of the first score relating to disabled accounts A of 1 signifies that every account associated with the feature value has been disabled.

The second score module 206 can generate a second score relating to manually disabled accounts B based on a second set of feature metrics. The second score relating to manually disabled accounts B can be calculated according to the following formula:

$$B = \frac{{M}^{2}}{{M}^{2} + {O}^{2}}$$

where M=number of manually disabled accounts and where O=D−M=number of disabled accounts that were not manually disabled. In some embodiments, a range of the second score relating to manually disabled accounts B is [0, 1]. For a particular feature value, a value of the second score relating to manually disabled accounts B of 1 signifies that every account associated with the feature value has been manually disabled.

The score combination module 208 can combine the first score relating to disabled accounts A and the second score relating to manually disabled accounts B to generate a combined score C. In some embodiments, the score combination module 208 can generate the combined score C according to the following formula:

$$C = \frac{A + B}{2}$$

The generation of the combined score C in this manner can constitute a more accurate predictor of illegitimate accounts because it does not rely on unreliable or inaccurate linear relationships, such as, for example, a conventional ratio of disabled accounts over all accounts or a conventional ratio of disabled accounts over active accounts. In addition, the combined score C is based on and optimally accounts for the second score relating to manually disabled accounts B, which provides a strong, reliable indication of illegitimacy. In some embodiments, the combined score C in relation to a threshold value can be used for a rule to identify and redress an account identified as illegitimate. In other implementations, the first score relating to disabled accounts A alone or the second score relating to manually disabled accounts B alone can be used for a rule to redress illegitimate accounts.

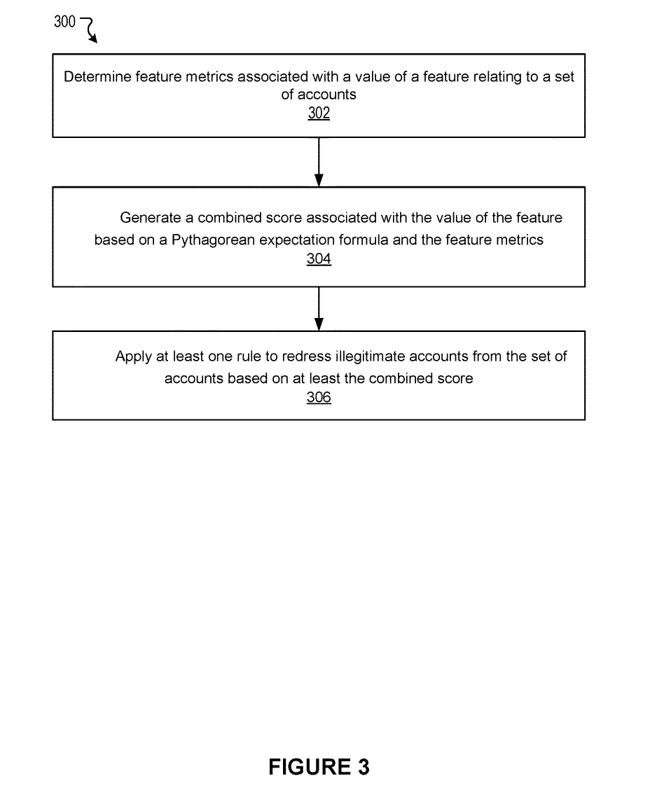

FIG. 3 illustrates an example method 300 to apply a rule to redress illegitimate accounts based on a combined score, according to an embodiment of the present technology. It should be appreciated that there can be additional, fewer, or alternative steps performed in similar or alternative orders, or in parallel, in accordance with the various embodiments and features discussed herein unless otherwise stated.

At block 302, the method 300 can determine feature metrics associated with a value of a feature relating to a set of accounts. At block 304, the method 300 can generate a combined score associated with the value of the feature based on a Pythagorean expectation formula and the feature metrics. At block 306, the method 300 can apply at least one rule to redress illegitimate accounts from the set of accounts based on at least the combined score. Other suitable techniques that incorporate various features and embodiments of the present technology are possible.

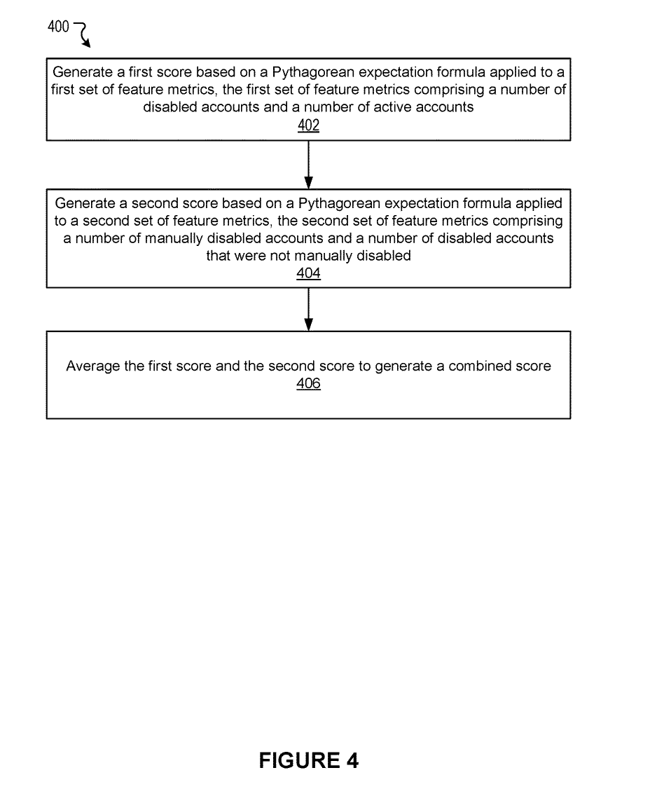

FIG. 4 illustrates an example method 400 to generate a combined score to identify illegitimate accounts, according to an embodiment of the present technology. It should be appreciated that there can be additional, fewer, or alternative steps performed in similar or alternative orders, or in parallel, in accordance with the various embodiments and features discussed herein unless otherwise stated.

At block 402, the method 400 can generate a first score based on a Pythagorean expectation formula applied to a first set of feature metrics, the first set of feature metrics comprising a number of disabled accounts and a number of active accounts. At block 404, the method 400 can generate a second score based on a Pythagorean expectation formula applied to a second set of feature metrics, the second set of feature metrics comprising a number of manually disabled accounts and a number of disabled accounts that were not manually disabled. At block 406, the method 400 can average the first score and the second score to generate a combined score. Other suitable techniques that incorporate various features and embodiments of the present technology are possible.

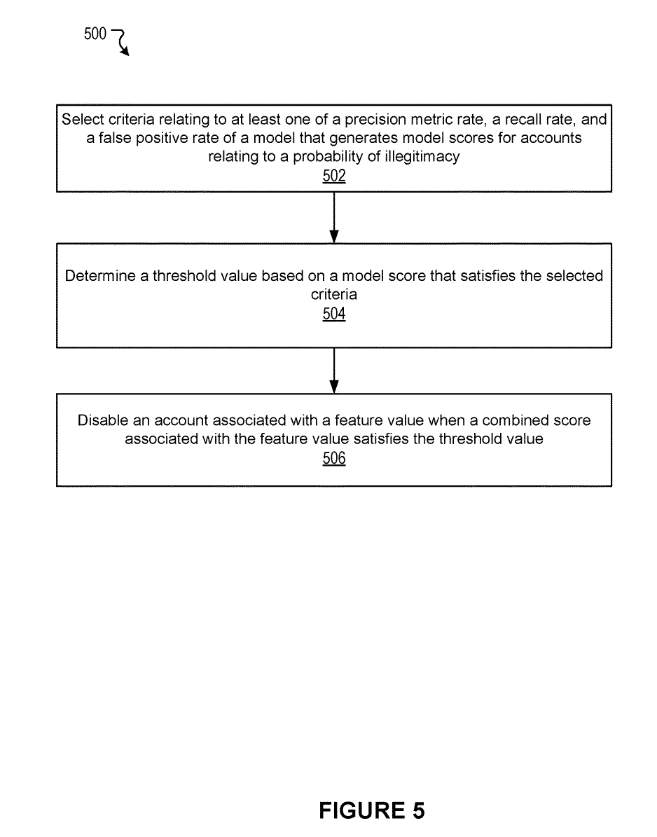

FIG. 5 illustrates an example method 500 to disable an account based on a combined score in relation to a threshold value, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can select criteria relating to at least one of a precision metric rate, a recall rate, and a false positive rate of a model that generates model scores for accounts relating to a probability of illegitimacy. At block 504, the method 500 can determine a threshold value based on a model score that satisfies the selected criteria. At block 506, the method 500 can disable an account associated with a feature value when a combined score associated with the feature value satisfies the threshold value. Other suitable techniques that incorporate various features and embodiments of the present technology are possible.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a fraud identification module 646. The fraud identification module 646 can be implemented with the fraud identification module 102, as discussed in more detail herein. In some embodiments, one or more functionalities of the fraud identification module 646 can be implemented in the user device 610.

### Hardware Implementation

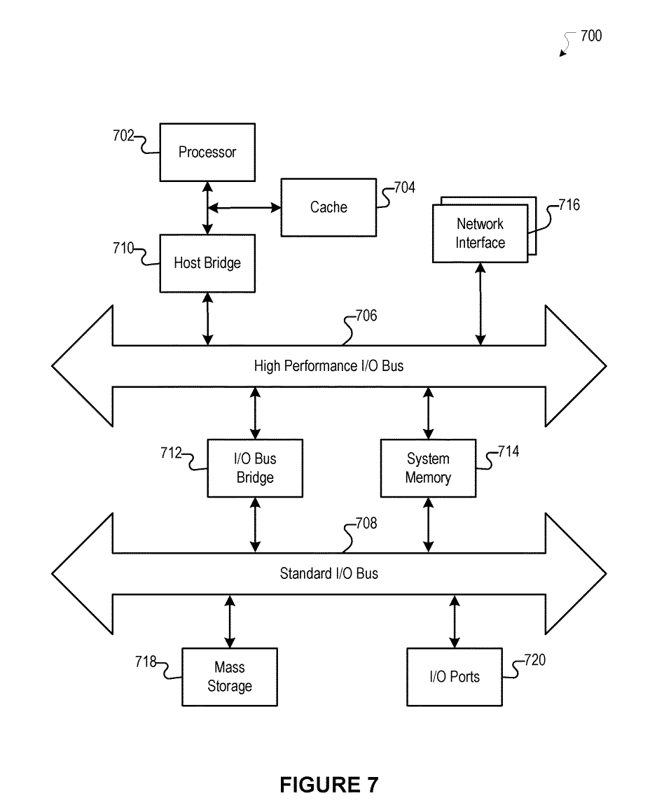

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, feature metrics associated with a value of a feature relating to a set of accounts;
generating, by the computing system, a combined score associated with the value of the feature based on a Pythagorean expectation formula and the feature metrics; and
applying, by the computing system, at least one rule to redress illegitimate accounts from the set of accounts based on at least the combined score.

2. The computer-implemented method of claim 1, wherein the generating a combined score comprises:
generating a first score based on a Pythagorean expectation formula applied to a first set of feature metrics.

3. The computer-implemented method of claim 2, wherein the first set of feature metrics comprises a number of disabled accounts and a number of active accounts.

4. The computer-implemented method of claim 3, wherein the generating a combined score further comprises:
generating a second score based on a Pythagorean expectation formula applied to a second set of feature metrics.

5. The computer-implemented method of claim 4, wherein the second set of feature metrics comprises a number of manually disabled accounts and a number of disabled accounts that were not manually disabled.

6. The computer-implemented method of claim 5, wherein the generating a combined score further comprises:
averaging the first score and the second score to generate the combined score.

7. The computer-implemented method of claim 1, wherein the applying at least one rule comprises:
selecting criteria relating to at least one of a precision metric rate, a recall rate, and a false positive rate of a model that generates model scores for accounts relating to a probability of illegitimacy; and
determining a threshold value based on a model score that satisfies the selected criteria.

8. The computer-implemented method of claim 7, wherein the at least one rule is further based on the threshold value.

9. The computer-implemented method of claim 8, wherein the applying at least one rule further comprises:
disabling an account associated with the value of the feature when the combined score satisfies the threshold value.

10. The computer-implemented method of claim 8, wherein the applying at least one rule further comprises:
not disabling an account associated with the value of the feature when the combined score does not satisfy the threshold value.

11. A system comprising:
at least one processor; and
a memory storing instructions that, when executed by the at least one processor, cause the system to perform:
determining feature metrics associated with a value of a feature relating to a set of accounts;
generating a combined score associated with the value of the feature based on a Pythagorean expectation formula and the feature metrics; and
applying at least one rule to redress illegitimate accounts from the set of accounts based on at least the combined score.

12. The system of claim 11, wherein the generating a combined score comprises:
generating a first score based on a Pythagorean expectation formula applied to a first set of feature metrics.

13. The system of claim 12, wherein the first set of feature metrics comprises a number of disabled accounts and a number of active accounts.

14. The system of claim 13, wherein the generating a combined score further comprises:
generating a second score based on a Pythagorean expectation formula applied to a second set of feature metrics.

15. The system of claim 14, wherein the second set of feature metrics comprises a number of manually disabled accounts and a number of disabled accounts that were not manually disabled.

16. A non-transitory computer-readable storage medium including instructions that, when executed by at least one processor of a computing system, cause the computing system to perform a method comprising:
determining feature metrics associated with a value of a feature relating to a set of accounts;
generating a combined score associated with the value of the feature based on a Pythagorean expectation formula and the feature metrics; and
applying at least one rule to redress illegitimate accounts from the set of accounts based on at least the combined score.

17. The non-transitory computer-readable storage medium of claim 16, wherein the generating a combined score comprises:
generating a first score based on a Pythagorean expectation formula applied to a first set of feature metrics.

18. The non-transitory computer-readable storage medium of claim 17, wherein the first set of feature metrics comprises a number of disabled accounts and a number of active accounts.

19. The non-transitory computer-readable storage medium of claim 18, wherein the generating a combined score further comprises:
generating a second score based on a Pythagorean expectation formula applied to a second set of feature metrics.

20. The non-transitory computer-readable storage medium of claim 19, wherein the second set of feature metrics comprises a number of manually disabled accounts and a number of disabled accounts that were not manually disabled.
